(19) United States
(12) Patent Application Publication
(10) Pub. No.: US 2004/0133313 A1
(43) Pub. Date: Jul. 8, 2004

(54) Method for analyzing readings of nucleic acid assays

(75) Inventor: Andrew M. Kuhn, Baltimore, MD (US)

Correspondence Address: PATTON BOGGS LLP, 8484 WESTPARK DRIVE, SUITE 900, MCLEAN, VA, 22102, US

(73) Assignee: BECTON, DICKINSON AND COMPANY, Franklin Lakes, NJ

(21) Appl. No.: 10/626,582

(22) Filed: Jul. 25, 2003

Related U.S. Application Data
(60) Provisional application No. 60/398,601, filed on Jul. 26, 2002.

(51) Int. Cl. G05B 21/00

(52) U.S. Cl. 700/266

(57) ABSTRACT

A computerized method and apparatus for analyzing numerical data pertaining to a sample assay comprising at least one biological sample, with the data including a set of data pertaining to each respective sample, and each set of data including a plurality of values each representing a condition of the respective sample at a point in time. The method and apparatus assigns a respective numerical value to each of the data values, corrects the data values by removing an additive background value from each of the data values, computes a single metric for each patient and compares that values to two known reference values to determine the genotype.

### CROSS-REFERENCE TO RELATED PATENT AND APPLICATION

This application is a utility patent application claiming benefit to previously filed U.S. Provisional Patent Application Serial No. 60/398,601 filed Jul. 26, 2002 and titled “Computerized Method and Apparatus for Analyzing Readings of Nucleic Assays”. Related subject matter is disclosed in a co-pending U.S. patent application of Andrew M. Kuhn, Tobin Hellyer, and Richard L. Moore entitled “Computerized Method and Apparatus for Analyzing Readings of Nucleic Acid Assays”, Ser. No. 09/574,031 and in U.S. Pat. No. 6,043,880 of Jeffrey P. Andrews, Christian V. O'Keefe, Brian G. Scrivens, Willard C. Pope, Timothy Hansen and Frank L. Failing entitled “Automated Optical Reader for Nucleic Acid Assays”, the entire contents of said application and patent being expressly incorporated herein by reference.

### BACKGROUND OF THE INVENTION

1. Field of the Invention

The present invention relates generally to a computerized method and apparatus for analyzing sets of readings taken of respective samples in a biological assay, such as a nucleic acid assay, to determine which samples possess a certain predetermined characteristic. More particularly, the present invention relates to a computerized method and apparatus that acquires optical readings of a biological sample taken at different times during a reading period, corrects for an additive background value present in the readings, and categorizes the corrected readings into one of several genetic variations (e.g., mutant, wild-type, etc.)

2. Description of the Related Art

Cataloging of the human genome has led to the discovery of millions of DNA sequence variations in humans, many of which are defined by a single nucleotide difference. In many cases, these single nucleotide polymorphisms (SNPs) can be associated with human diseases and conditions so that genotyping of patients can aid in the diagnosis and treatment of many conditions.

The determination of a patient's genotype can be accomplished in various ways. Sequencing of a patient's DNA is a relatively expensive and time-consuming process. Other methods, such as DNA probes, can identify the presence of specific target sequences quickly and reliably. A test for the presence of a particular sequence of DNA can be completed in an hour or less using DNA probe technology.

In the use of DNA probes for clinical diagnostic purposes, a nucleic acid amplification reaction is usually carried out to multiply the target nucleic acid into many copies or amplicons. Examples of nucleic acid amplification reactions include strand displacement amplification (SDA) and polymerase chain reaction (PCR). Unlike PCR, SDA is an isothermal process that does not require any external control over the progress of the reaction that causes amplification. Detection of the nucleic acid amplicons can be carried out in several ways, all involving hybridization (binding) between the target DNA and specific probes.

Many common DNA probe detection methods involve the use of fluorescent dyes. One known detection method is fluorescence energy transfer. In this method, a detector probe is labeled with both a fluorescent dye that emits light when excited by an outside source and a quencher that suppresses the emission of light from the fluorescent dye in its native state. When DNA amplification occurs, the fluorescently labeled probe binds to the resulting amplicons, undergoing a change in secondary structure in the process that separates the fluor from the quencher molecule, thereby allowing fluorescence to be detected. The change in fluorescence is taken as an indication that the targeted DNA sequence is present in the sample.

Several types of optical readers or scanners exist that are capable of exciting fluid samples with light and then detecting any light that is generated by the fluid samples in response to the excitation. For example, an X-Y plate scanning apparatus, such as the CytoFluor Series 4000 made by PerSeptive Biosystems, is capable of scanning a plurality of fluid samples stored in an array of microwells. The apparatus includes a scanning head for emitting light towards a particular sample and for detecting light generated from that sample. During operation, the optical head is moved to a suitable position with respect to one of the sample wells. A light-emitting device is activated to transmit light through the optical head toward the sample well. If the fluid sample in the well fluoresces in response to the emitted light, the fluorescent light is received by the scanning head and transmitted to an optical detector. The detected light is converted by the optical detector into an electrical signal, the magnitude of which is indicative of the intensity of the detected light. This electrical signal is processed by a computer to determine whether the target DNA is present or absent in the fluid sample based on the magnitude of the electrical signal. Each well in the microwell tray (e.g., 96 microwells total) can be read in this manner.

Another more efficient and versatile sample well reading apparatus known as the BDProbeTec® ET system manufactured by Becton, Dickinson and Company is described in the above-referenced U.S. Pat. No. 6,043,880. In that system, a microwell array, such as the standard microwell array having 12 columns of eight microwells each (96 microwells total), is placed in a moveable stage that is driven past a scanning bar. The scanning bar includes eight light emitting/detecting ports that are spaced from each other at a distance substantially corresponding to the distance at which the microwells in each column are spaced from each other. Hence, an entire column of sample microwells can be read with each movement of the stage.

As described in more detail below, the stage is moved back and forth over the light sensing bar, so that a plurality of readings of each sample microwell are taken at desired intervals. In one example, readings of each microwell are taken at one-minute intervals for a period of one hour. Accordingly, 60 readings of each microwell are taken during a well reading period. These readings are then used to determine which samples contain the particular targeted disease or condition.

Several methods are known for analyzing the sample well reading data to determine whether a sample contained in the sample well includes the targeted genetic sequence(s). For instance, as discussed above, a nucleic acid amplification reaction will cause the target nucleic acid to multiply into many amplicons. The fluorescently-labeled probe that binds to the amplicons will fluoresce when excited with light. As the number of amplicons increases over time while the nucleic acid amplification reaction progresses, the amount of fluorescence correspondingly increases. Accordingly, after a predetermined period of time has elapsed (e.g., 1 hour), the magnitude of fluorescence emission from a sample having the targeted sequence (a “positive”) is much greater then the magnitude of fluorescence emission from a sample not having the targeted sequence (a “negative”). The magnitude of fluorescence of a sample without the targeted sequence essentially does not change throughout the duration of the test.

Although the embodiments of this invention have been described in terms of increasing signal as amplification increases, there are similar systems where signal (fluorescence, etc.) decreases as amplification proceeds. Those skilled in the art will appreciate that such modifications are possible in the exemplary embodiments without materially departing from the novel teachings and advantages of this invention. Accordingly, all such modifications are intended to be included within the scope of this invention.

If present in the sample, the two target sequences, such as alleles A and B, are amplified through this procedure (in the same or separate microwells). The magnitude of amplification of each sequence could be compared to the other to determine the patient's genetic makeup. If the magnitude of fluorescence emission is large for allele A sequence and small for allele B, the patient's genotype would be homozygous for allele A. Conversely, if the magnitude of fluorescence emission is large for allele B and small for allele A, the patient would be homozygous for allele B. If both sequences showed significant fluorescence emissions, both sequences are present and the patient is heterozygous for alleles A and B.

Therefore, the value of the last reading taken for each sequence can be compared to categorize the sample into one of several characteristics (e.g., allele A, allele B, heterozygous for alleles A and B). If neither sequence shows significant fluorescence emissions, one or both of the amplifications was inhibited by factors unrelated to the presence of the target sequences.

Although this “endpoint detection” method can generally be effective in identifying the presence of a target DNA sequence, it is not uncommon for this method to incorrectly identify a “negative” sample as being “positive” for the sequence or vice versa. That is, the accuracy of the value of any-individual sample reading can be adversely effected by factors such as a bubble forming in the sample, obstruction of excitation light and/or fluorescence emission from the sample because of the presence of debris on the optical reader, and so on. Accordingly, if the final reading of a particular sample is erroneous and only that reading is analyzed, the likelihood of obtaining an erroneous result is high.

To avoid these drawbacks, other methods have been developed. In one method, the overall change in the magnitudes of sample readings is calculated and compared to a known value having a magnitude indicative of a positive result. Accordingly, if the magnitude of change is greater than the predetermined value, the sample is identified as a positive sample containing the targeted sequence. On the other hand, if the magnitude of change is less than the predetermined value, the sample is identified as not containing the targeted sequence.

Another known method is the acceleration index method, which measures incremental changes in the sample readings and compares those changes to a predetermined value. Although this method is generally effective, the accuracy of its results is susceptible to errors present in the individual readings.

Accordingly, a continuing need exists for a method and apparatus to analyze data representative of readings taken of sample wells in order to classify the sample into one of a variety of genetic variations.

### SUMMARY OF THE INVENTION

An object of the present invention is to provide a method and apparatus for accurately interpreting the values of data obtained from taking readings of a biological sample to ascertain the particular genotype in the sample based on the data values.

Another object of the invention is to provide a method and apparatus for use with an optical sample well reader, which accurately interprets data representing magnitudes of fluorescence emissions detected from the sample at predetermined periods of time, to ascertain the particular genotype in the sample.

A further object of the invention is to provide a method and apparatus for analyzing data obtained from reading a biological sample contained in a sample well, and without using complicated arithmetic computations, correcting for errors in the data that could adversely affect the results of the analysis.

These and other objects of the invention are substantially achieved by providing a computerized method and apparatus for analyzing numerical data pertaining to a sample assay comprising at least one biological sample, with the data including a set of data pertaining to each respective sample, and each set of data including a plurality of values each representing a condition of the respective sample at a point in time. The method and apparatus assigns a respective numerical value to each of the data values, removes an additive background value from each of the data values to produce corrected data values, compares the amplification results from two nucleic acid sequences to differentiate sequence variations, and controls the system to indicate the patient genotype based on a result of the comparison. Additionally, prior to differentiating sequence variation, filtering, normalizing and other correcting operations can be performed on the data to correct extraneous values in the data that could adversely affect the accuracy of the results.

The method and apparatus can perform many of the above functions by representing the plurality of data values for each target sequence as points on a graph having a vertical axis representing the magnitudes of the values and a horizontal axis representing a period of time during which readings of the sample were taken to obtain said plurality of data values, correcting the data values from each sequence to eliminate an additive background value present in each of the data values to produce a corrected plot of points on the graph for each target sequence, with each of the points for each sequence of the corrected plot of points representing a magnitude of a corresponding one of the values. Another plurality of values is created that describes the relative magnitudes of the pluralities for each target sequence (e.g., allele A or allele B, mutant or wild-type) by taking logarithm of the ratio of allele A to allele B data values. This plurality of values is then summarized into a single metric for each patient sample by the most likely value in plurality of values based on a probability density estimate. This most likely value is compared to two known reference values to determine the genotype (e.g., allele A, allele B or heterozygous). For example, if the most likely value is between the two reference values, the sample may be determined to be heterozygous. If the value were above the larger (smaller) reference value, the sample would be allele A (allele B). The configuration of the reference values would depend on what target sequences are associated with each amplification curve.

### BRIEF DESCRIPTION OF THE DRAWINGS

The and other objects of the invention will be more readily appreciated from the following detailed description when read in conjunction with the accompanying drawings in which:

FIG. 1 is a perspective view of an apparatus for optically reading sample wells of a sample well array, which employs an embodiment of the present invention to interpret the sample well readings;

FIG. 2 is an exploded perspective view of a sample well tray for use in the sample well reading apparatus shown in FIG. 1;

FIG. 3 is a detailed perspective view of a stage assembly employed in the apparatus shown in FIG. 1 for receiving and conveying a sample well tray assembly shown in FIG. 2;

FIG. 4 is a diagram illustrating the layout of a light sensor bar and corresponding fiber optic cables, light emitting diodes and light detector employed in the apparatus shown in FIG. 1, in relation to a sample well tray being conveyed past the light sensor bar by the stage assembly shown in FIG. 3;

FIG. 5 is a graph illustrating values representing the magnitudes of fluorescent emissions detected from a sample well of the sample well tray shown in FIG. 2 by the apparatus shown in FIG. 1, with the values being plotted as a function of the times at which their corresponding fluorescent emissions were detected;

FIG. 6 is a flowchart showing steps of a method for normalizing, filtering, adjusting and interpreting the data in the graph shown in FIG. 5 according to an embodiment of the present invention;

FIG. 7 is a flowchart showing steps of the dark correction processing step of the flowchart shown in FIG. 6;

FIG. 8 is a flowchart showing steps of the dynamic normalization processing step of the flowchart shown in FIG. 6;

FIG. 9 is a graph that results after performing the dark correction, impulse noise filter, and dynamic normalization steps in the flowchart show in FIG. 6 on the graph shown in FIG. 5;

FIG. 10 is a flowchart showing steps of the step location and removal processing step of the flowchart show in FIG. 6;

FIG. 11 is a graph that results from performing the step location and repair steps of the flowchart shown in FIG. 6 on the graph shown in FIG. 9;

FIG. 12 is a flowchart showing steps of the well present determination step of the flowchart shown in FIG. 6;

FIG. 13 is a flowchart showing steps of the background correction step of the flowchart shown in FIG. 6;

FIG. 14 is a graph that results from performing the background correction step of the flowchart shown in FIG. 6 on the graph in FIG. 11;

FIG. 15 is a flowchart showing steps of calculating the natural logarithm of amplification ratios;

FIG. 16 is a flowchart showing the steps of density estimation for the log ratio values and determining the ratio value corresponding to the point of maximum density;

FIG. 17 is a flowchart showing steps of assigning a final result to the sample using the maximum density value(s);

FIG. 18 is a graph of mutant and wild-type amplifications for the example;

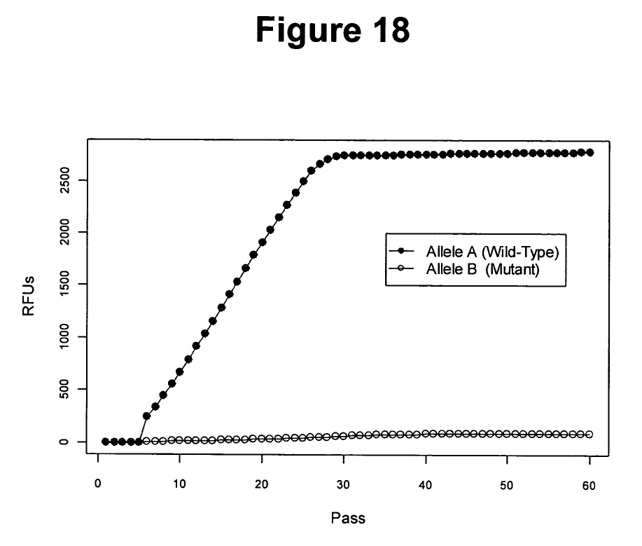

FIG. 19 is a graph of log ratio data values over time for the example;

FIG. 20 is a histogram of log ratio data values and probability density curve for the example; and

FIG. 21 is a graph demonstrating the most likely value for the example.

### DETAILED DESCRIPTION

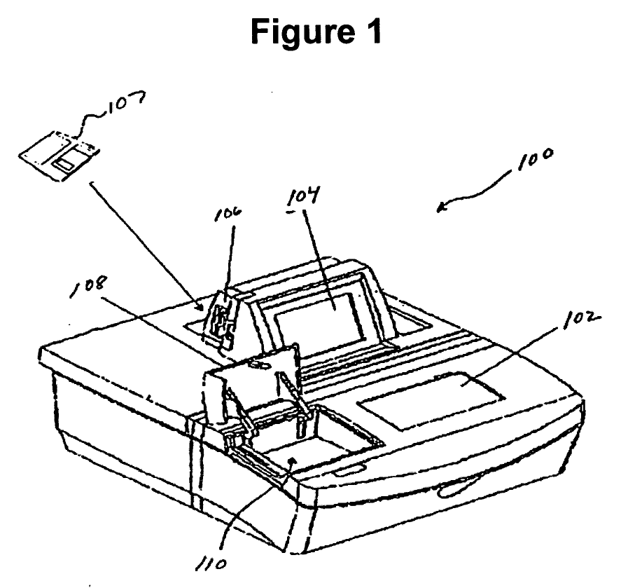

A well reading apparatus 100 according to an embodiment of the present invention is shown in FIG. 1. The apparatus 100 includes a keypad 102, which enables an operator to enter data and thus control operation of the apparatus 100. The apparatus 100 further includes a display screen 104, such as an LCD display screen or the like, for displaying “soft keys” that allow the operator to enter data and control operation of the apparatus 100, and for displaying information in response to the operator's commands, as well as data pertaining to the scanning information gathered from the samples in the manner described below. The apparatus also includes a storage device such as a disk drive 106 for storing data generated by the apparatus 100 or from which the apparatus can read data.

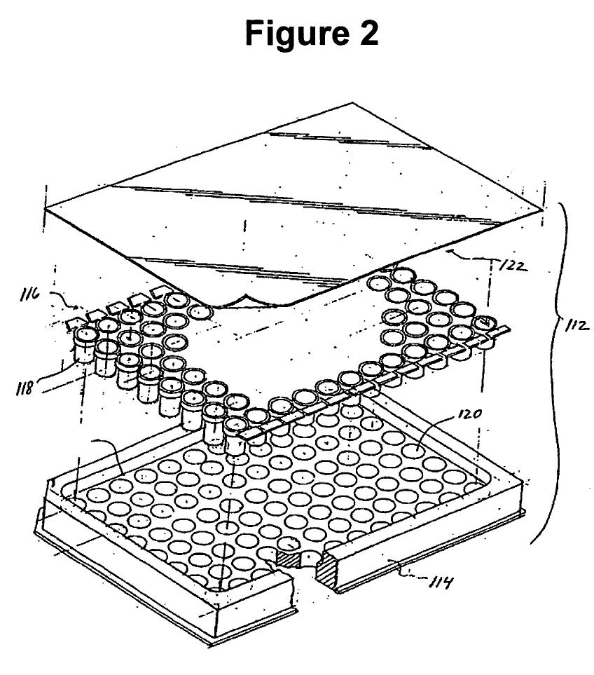

The apparatus 100 further includes a door 108 that allows access to a stage assembly 110 and into which can be loaded a sample tray assembly 112. As shown in FIG. 2, a sample tray assembly 112 includes a tray 114 into which is loaded a microwell array 116, which can be a standard microwell array having 96 individual microwells 118 arranged in 12 columns of 8 microwells each. The tray 114 has openings 120, which pass entirely through the tray and are arranged in 12 columns of eight microwells each, such that each opening 120 accommodates a microwell 118 of microwell array 116. After the samples have been placed into the microwells 118, a cover 122 can be secured over microwells 118 to retain each fluid sample in its respective microwell 118. Further details of the sample tray assembly 112 and of sample collection techniques are described in the aforementioned U.S. Pat. No. 6,043,880.

Each microwell can include two types of detector probes, as described below, for identifying a particular disease or for characterizing a genetic locus with one probe being specific for each allele. If the microwell array 116 is to be used to test for a particular disease or condition in each patient sample, the microwells 118 are arranged in groups of microwells and a fluid sample from a particular patient is placed in the group of wells corresponding to the particular patient.

Some of the 96 microwells 118 in the microwell array 116 can be designated as control sample wells for a particular genotype, with one of the control sample wells containing a homozygous allele A sample, the other control well containing a control homozygous allele B sample, and a third microwell containing a heterozygous mixture of both alleles A and B. Also, additional microwells 118 that do not contain either allele can be designated as negative control microwells. Accordingly, in this example, a maximum of 92 patient samples can be tested for each microwell array 116 arranged in this manner (i.e., 92 samples plus 1 allele A control, 1 allele B control, 1 heterozygous control containing a mixture of alleles A and B and 1 negative control).

Although the above description focuses on testing of patient samples, a similar approach can be used to test haploid organisms such as bacteria for genetic mutations. In this case, each microwell is used to discriminate the two alleles at a particular locus while appropriate positive and negative controls are also included for each genetic variant. Analysis of the fluorescent readings from the samples is similar regardless of the source of nucleic acid target.

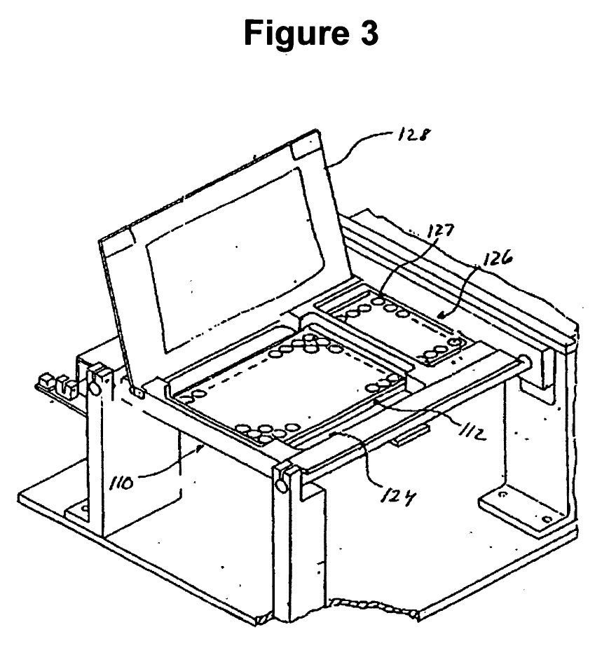

After the patient fluid samples have been placed in the appropriate microwells 118 of the microwell array 116 in sample tray assembly 112, the sample tray assembly 112 is loaded into the stage assembly 110 of the well reading apparatus 100. The stage assembly 110 is shown in more detail in FIG. 3. Specifically the stage assembly 110 includes an opening 124 for receiving a sample tray assembly 112. The stage assembly 110 further includes a plurality of control wells 126 that are used in calibrating and verifying the integrity of the reading components of the well reading apparatus 100. Among these control wells 126 is a column of eight calibration wells 127, the purpose of which is described in more detail below. The stage assembly 110 further includes a cover 128 that covers the sample tray assembly 112 and control wells 126 when the sample tray assembly 112 has been loaded into the opening 124 and sample reading is to begin. Further details of the stage assembly 110 are described in the above-referenced U.S. Pat. No. 6,043,880.

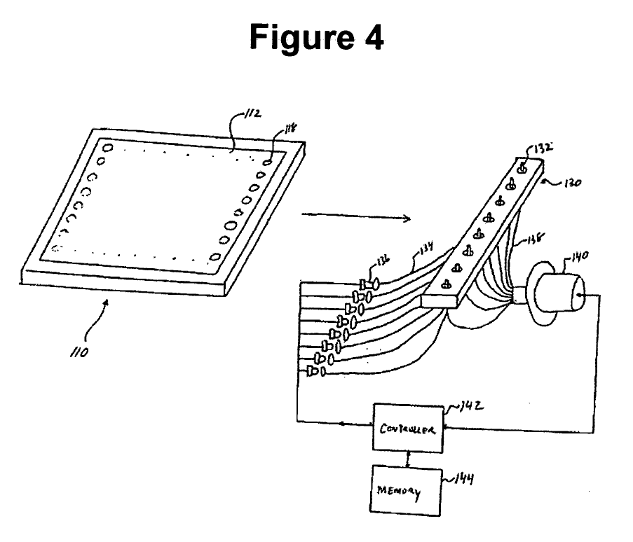

To read the samples contained in the microwells 118 of a sample tray assembly 112 that has been loaded into the stage assembly 110, the stage assembly 110 is conveyed past a light sensing bar 130 as shown in FIG. 4. The light sensor bar 130 includes a plurality of light emitting/detecting ports 132. The light emitting/detecting ports 132 are controlled to emit light towards a column of eight microwells 118 when the stage assembly 110 positions those microwells 118 over the light emitting/detecting ports, and to detect fluorescent light being emitted from the samples contained in those microwells 118. In this example, the light sensor bar 130 includes eight light emitting/detecting ports 132 that are arranged to substantially align with the eight microwells 118 in a column of the microwell array 116 when that column of microwells 118 is positioned over the light emitting/detecting ports 132.

The light emitting/detecting ports 132 are coupled by respective fiber optic cables 134 to respective light emitting devices 136, such as LEDs or the like. The light emitting/detecting ports 132 are further coupled by respective fiber optic cables 138 to an optical detector 140, such as a photo multiplier tube or the like. Further details of the light sensor bar 130 and related components, as well as the manner in which the stage assembly 110 is conveyed past the light sensor bar 130 for reading the samples contained in the microwells 118, are described in the above-referenced U.S. Pat. No. 6,043,880.

In general, one reading for each microwell is taken at a particular interval in time, and additional readings of each microwell are taken at respective intervals in time for a predetermined duration of time. In this example, one microwell reading is obtained for each microwell 118 at approximately one-minute intervals for a period of one hour. One reading of each of the calibration wells 127, as well as one “dark” reading for each of the light emitting/detecting ports 132, is taken at each one-minute interval. Accordingly, 60 microwell readings of each microwell 118, as well as 60 readings of each calibration well 127 and 60 dark readings, are obtained during the one-hour period.

Additionally, this embodiment of the well reading apparatus has two independent optical systems, one for FAM dyes and one for ROX dyes. Each optical system contains eight optical channels, one for each row of a standard 96-well microtiter plate. An optical channel consists of a source LED, excitation filters, and a bifurcated fiber optic bundle that integrates source fibers and emission fibers into a single read position. All optical channels within one optical system terminate in a common set of emission filters and a photo multiplier tube (PMT). Each bifurcated fiber optic bundle couples light from the source LED to a position on the read head that interrogates a single well within a row of the microtiter plate 114. The integrated ends of the eight optical fiber bundles for each optical system are attached to their respective read head that are positioned under a moving stage 110. This configuration allows the row position to be selected by activating the appropriate LED, and the column position determined by moving the stage 110. During operation, if fluid sample fluoresces in response to the emitted source light, the light produced by the fluorescence is received by the integrated end of the optical fiber and is transmitted through the second optical fiber to the PMT. The detected light is converted by the PMT into an electrical current, the magnitude of which is indicative of the intensity of the detected light.

A reading is a measurement of the intensity of the fluorescent emission being generated by a microwell sample in response to excitation light emitted onto the sample. These intensity values are stored in magnitudes of relative fluorescent units (RFU). A reading of a sample having a high magnitude of fluorescent emissions will provide an RFU value much higher then that provided by a reading taken of a sample having low fluorescent emissions.

Once the total number of readings (e.g., 60 readings) for each sample well have been taken, the readings for each sample must be interpreted by the well reading apparatus 100 so the well reading apparatus 100 can determine the presence of the targeted sequences and differentiate sequence variations. The micro processing unit of the well reading apparatus 100 is controlled by software to perform the following operations on the data representing the sample well readings. The operations being described are applied in essentially the same manner to the readings taken for each sample microwell 118. Accordingly, for illustrative purposes, the operations will be described with regard to readings taken for one sample microwell 118, which will be referred to as the first sample microwell 118.

As discussed above, during each one-minute interval in which all of the microwells 118 in the sample tray assembly 112 are read, the light sensor bar 130 reads the calibration wells one time. Hence, after 60 readings of each microwell sample have been taken, each calibration well 127 has been read 60 times by its respective light emitting/detecting port 132 of the light sensor bar 130, which results in eight sets of 60 calibration well readings. For illustrative purposes, the calibration readings of the calibration well 127 that has been read by the light emitting/detecting port 132, which has also read the first sample microwell 118 now being discussed, are represented as n₁ through n₆₀. This procedure occurs for each of the fluorescent dyes.

Additionally, as discussed above, during each one-minute interval, the optical detector 140 is controlled to obtain a “dark” reading in which a reading is taken without any of the light emitting devices 136 being activated. This allows the optical detector 140 to detect any ambient light that may be present in the system. The dark readings are taken for each light emitting/detecting port 132. Accordingly, after 60 readings of every microwell 118 have been obtained, eight sets of 60 dark readings (i.e., one set of 60 dark readings for each of the eight light emitting/detecting portions 132) have been obtained. For illustrative purposes, the dark readings obtained by the light emitting/detecting port 132, which read the first sample microwell 118 now being discussed, are represented as d₁ through d₆₀.

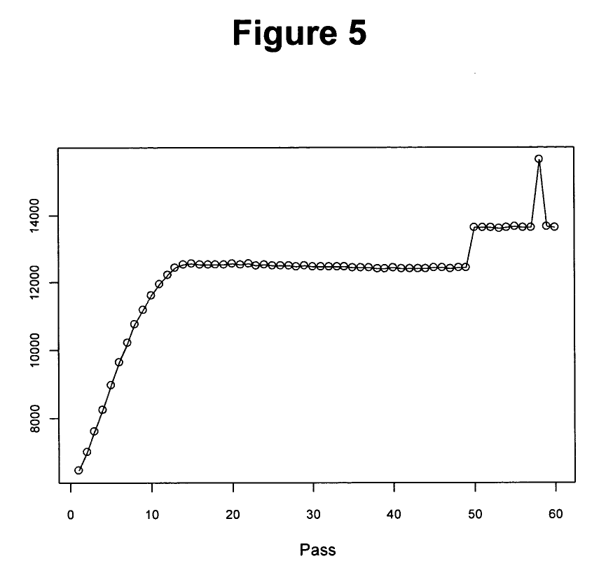

FIG. 5 is a graph showing the relationship of the 60 readings for one well that have been obtained during the one-hour reading period for one of the two targeted sequences. For illustrative purposes, these readings are represented as r₁ through r₆₀. These readings are plotted on the graph of FIG. 5 with their RFU value being represented on the vertical axis with respect to the time in minutes at which the readings were taken during the reading period.

As can be appreciated from the graph, the RFU values for the readings taken later in the reading period are greater than the RFU values of the readings taken at the beginning of the reading. For illustrative purposes, this example shows the trend in readings for a well that contains the particular target sequence for which the well is being tested.

As can also be appreciated from FIG. 5, the graph of the “raw data” readings includes a noise spike and a step as shown. The process that will now be described eliminates any noise spikes, steps or other apparent abnormalities in the graphs that are the result of erroneous readings being taken of the sample well.

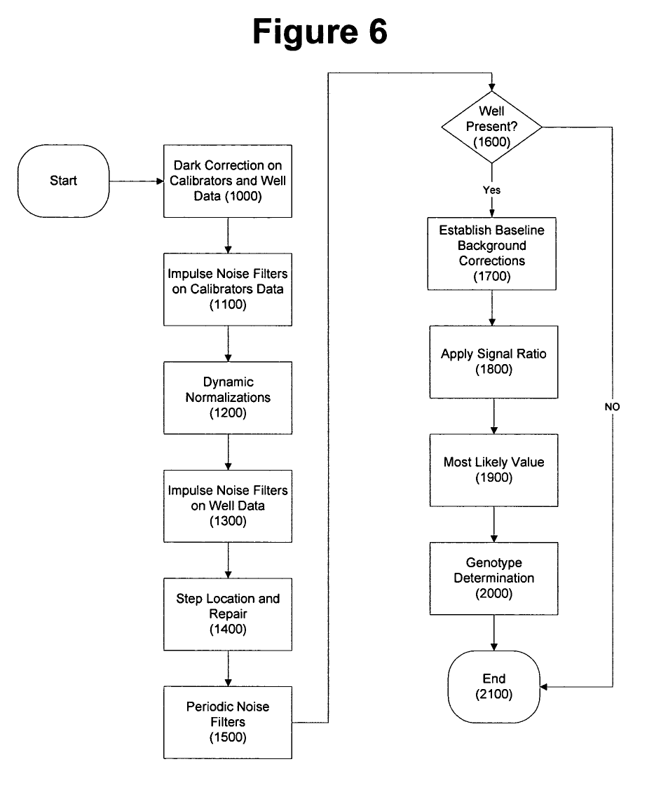

The flowchart shown in FIG. 6 represents the overall process for interpreting the graph of well readings r₁ through r₆₀ shown in FIG. 5 to determine whether the well sample includes the particular target sequence(s) and the resulting genotype for which it is being tested. Steps 1000 through 1700 in FIG. 6 are applied separately to each of the two pluralities of target sequence data values. These pluralities may result from readings of two fluorescent wavelengths, each corresponding to a separate target sequence. The processes in FIG. 6 are performed by the controller (not shown) of the well reading apparatus 100 as controlled by software, which can be stored in a memory (not shown) resident in the well reading apparatus 100 or on a disk inserted into disk drive 106.

Data Value Correction

The first process performed by the controller is data value correction. One skilled in the art will appreciate that the process of correcting the data values to correct or eliminate incorrect values may be performed following a variety of processes. For example, the followings steps may be performed to correct the data values prior to reducing the data values to a single value used for determining how the sample is categorized.

Dark Correction Operation

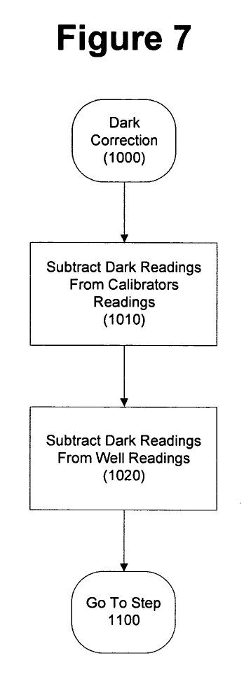

As shown in FIG. 6, the software initially controls the controller to perform a dark correction on the calibrator data readings n₁ through n⁶⁰ and on the well readings r₁ through r₆₀. The details of this step are shown in the flowchart of FIG. 7.

In particular, in Step 1010, the dark reading values d₁ through d₆₀ are subtracted from the corresponding calibrator reading values n₁ through n₆₀, respectively, to provide corrected calibrator readings cn₁ through cn₆₀, respectively. That is, dark reading d₁ is subtracted from calibrator reading r₁ to provide corrected calibrator reading cn₁, dark reading d₂ is subtracted from calibrator reading n₂ to provide corrected calibrator reading cn₂, and so on.

The processing then proceeds to Step 1020 in which the dark readings d₁ through d₆₀ are subtracted from their corresponding well readings r₁ through r₆₀, respectively to provide corrected well readings cr₁ through cr₆₀, respectively. That is, dark well reading d₁ is subtracted from well reading r₁ to provide corrected well reading c₁, dark reading d₂ is subtracted from well reading r₂ to provide corrected well reading cr₂, respectively, and so on.

Smoothing Operation

After all of the corrected calibrator readings and corrected well readings have been obtained, the processing continues to the filtering operations Step 1100 of the flowchart shown in FIG. 6, in which noise is filtered from the corrected calibrator readings cn₁ through cn₆₀, which were obtained during Step 1010 described above. In an embodiment, a 5-point running median is applied to the corrected calibrator readings cn₁ through cn₆₀ to produce smoothed calibrator values, denoted as xn₁ through xn⁶⁰.

Normalization Operation

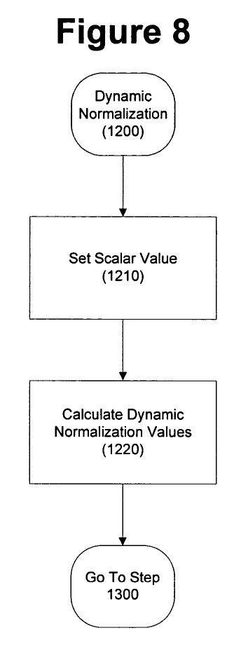

Once all smoothed calibrator values xn₁ through xn⁶⁰ have been obtained, the processing continues to the dynamic normalization step 1200 shown in the flowchart of FIG. 6. The details of the dynamic normalization process are shown in the flowchart of FIG. 8. Specifically in this example, the smoothed calibrator values xn₁ through xn⁶⁰, as well as the corrected well reading values cr₁ through cr₆₀, are used to calculate dynamic normalization values in nr₁ through nr₆₀.

In Step 1210, an arbitrary scalar value is set, which is employed in the calculations. In this example, the scalar value is 3000. The processing then proceeds to Step 1220, where the scalar value, corrected well reading values, and smoothed normalized values are used to calculate dynamic normalization values. In particular, to calculate the dynamic normalization values, the corresponding corrected well value is multiplied by the scalar value and then that product is divided by the corresponding smoothed calibrator value. For instance, to obtain dynamic normalization value nr₁, corrected well reading value cr₁ is multiplied by 3000 (the scalar value) and then that product is divided by the value of smoothed calibrator xn₁. Similarly, dynamic normalization value nr₂ is calculated by multiplying corrected well reading value cr₂ by 3000 and then dividing that product by smoothed calibrator value xn². This process continues until all 60 dynamic normalization values nr₁ through nr₆₀ have been obtained.

Noise Spike Removal

The processing then continues to perform the impulse noise filtering operation on the well data as shown in Step 1300 of the flowchart in FIG. 6. In Step 1300, a smoothing procedure is applied to the dynamic normalization values nr₁ through nr₆₀ to obtain smoothed normalized values x₁ through x₆₀. In an embodiment, the process includes two iterations of a three point running median filter.

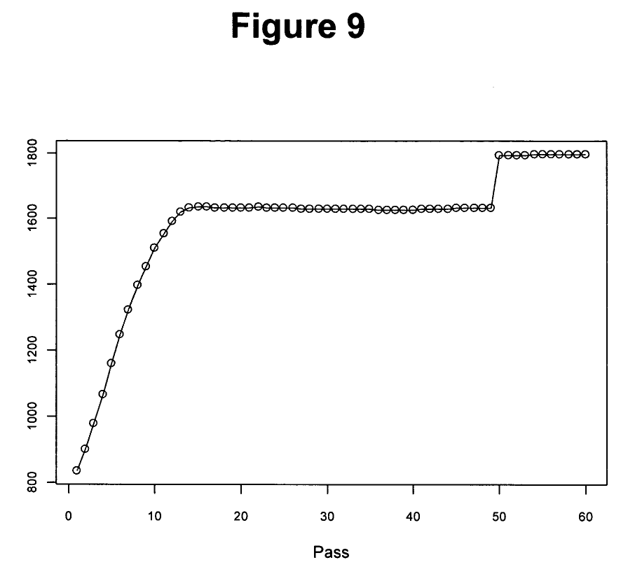

After Steps 1000 through 1300 of the flowchart in FIG. 6 have been performed as described above, the well readings have, therefore, been smoothened and normalized and are represented by the second smoothed normalized values z₁ through Z₅₀. Accordingly, as shown in the graph of FIG. 9, when the second smoothed normalized values z₁ through z₆₀ are plotted with respect to a corresponding time periods in which their corresponding well readings have been obtained, the noise spike in the graph has been eliminated.

However, these smoothing and normalizing operations did not remove the step, which is present in the graph as shown in FIG. 9. This increase in the reading values, which resulted in the step appearing in the graph, was likely caused by the presence of a bubble in the well that formed after the 50^{th} well reading was obtained (i.e., after an elapsed time of 50 minutes), but before the 51^{th} well reading was obtained. Accordingly, the magnitude of well reading values r₅₁ through r₆₀ and, hence, the magnitude of smoothed and normalized values z₅₁ through z₆₀ have been increased because of the presence of this bubble. Therefore, it is necessary to reduce the smoothed normalized values z₅₁ through z₆₀ by a value proportionate to the size of the step.

Step Removal

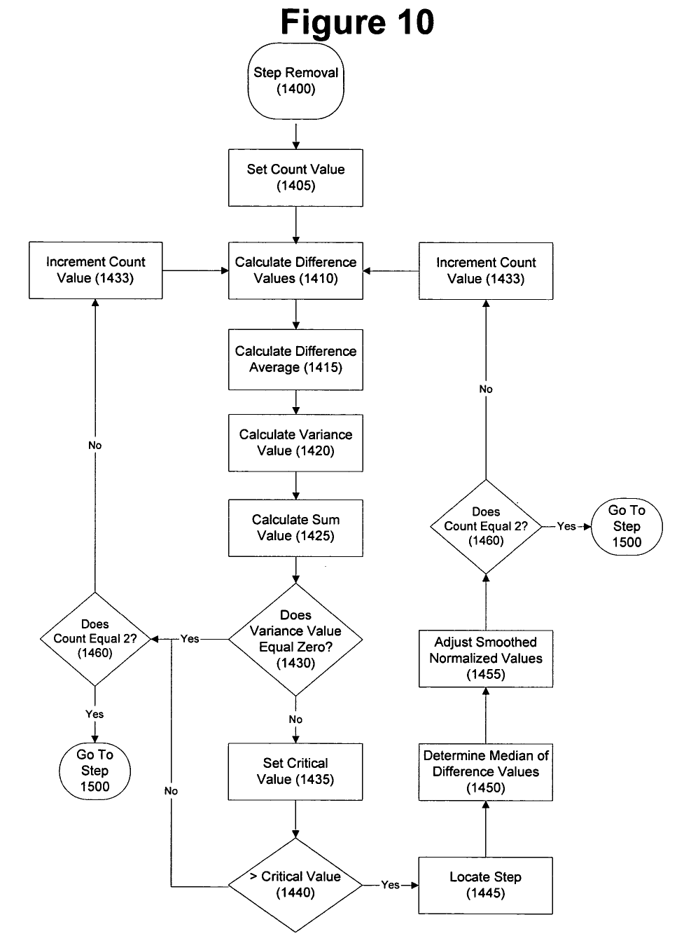

Step Detection. The step removal operation is performed in Step 1400 as shown in the flowchart in FIG. 6. Details of the step removal operation are set forth in the flowchart in FIG. 10.

It has been determined that graphs of these types generally will have only one or possibly two steps and will almost never have more than two steps. Accordingly, all of the steps in the graph will have been located and removed after performing the step locating process two times. Accordingly, in Step 1405 in the flowchart of FIG. 10, a count value is set to allow the process to repeat a maximum of times. In this example, the count value is set at two to allow the process to repeat two times. The process then proceeds to step 1410, where difference values dr₁ through dr₅₉ are calculated, which represent the differences between adjacent second smoothed normalized value z₁ through Z₆₀. That is, the first difference value dr₁ is calculated as the value of second smoothed normalized value z₂ minus second smoothed normalized value z₁. The second difference value dr₂ is calculated as the value of second smoothed normalized value Z₃ minus second smoothed normalized value z₂. This process is repeated until 59 difference values dr₁ through dr₅₉ have been obtained.

The processing then continues to Step 1415, in which the difference values dr₁ through dr₅₉ are added together to provide an average total, which is then divided by 59 to provide a difference average 'dr. The processing then continues to Step 1420, where a variance value var(dr) is calculated using a standard statistical formula.

The process then continues to Step 1425 where a sum value “s” is calculated. This sum value is calculated by subtracting the difference average 'dr from each of the difference values dr₁ through dr₅₉, taking each result to the fourth power to obtain a set of 59 quadrupled results, and then adding all of the 59 quadrupled results. That is, the difference average 'dr is subtracted from the first difference value dr₁ to provide a first result. That first result is then taken to the fourth power to provide a first quadrupled result. The difference average 'dr is subtracted from second difference value dr₂, and the second result of the subtraction is taken to the fourth power to provide a second quadrupled result. This process is repeated for the remaining difference values dr₃ through dr₅₉ until all 59 quadrupled results have been calculated. The 59 quadrupled results are then added to provide the sum value “s”.

In Step 1430, the processing determines whether the process of removing the step is complete by determining if the variance value var(dr) is equal to zero. If the value of var(dr) is equal to zero, the processing proceeds to Step 1460, where it is determined whether the count value is equal to 2. If the count value is equal to 2, the process continues to Steps 1500. If the process is in its first iteration, the process continues to Step 1433, where the count value is incremented by one, and Steps 1410 through 1425 are repeated as discussed above. However, if the value of var(dr) is not equal to zero, then the step detection process can proceed. To determine if the step is present, in Step 1435, a critical value CRIT_VAL is set equal to 4.9. This critical value is generally chosen to maximize the probability of detecting a step based on statistical theory. The processing then proceeds to Step 1440, where it is determined whether the quotient of the sum value “s” divided by the product of var(dr) squared and multiplied by 59 is greater than the CRIT_VAL. If the calculated quotient is not greater than CRIT_VAL, then a step is not present, and the processing continues to Step 1433.

Step Removal. However, if the quotient is greater than the value of CRIT_VAL, then the processing proceeds to Step 1445 where processing will be performed to determine the location of the step. This is accomplished by subtracting the difference average 'dr from each of the 1 through 59 difference values dr₁ through dr₅₉ to produce a difference result taking the absolute value of each of those difference results. The step corresponds to the pass associated with largest of the absolute values. Denote the pass where the step has occurred as maxpt_dr. As discussed above, in this example, it is presumed that the step occurred at value z₅₀. Accordingly, maxpt_dr is set to 50.

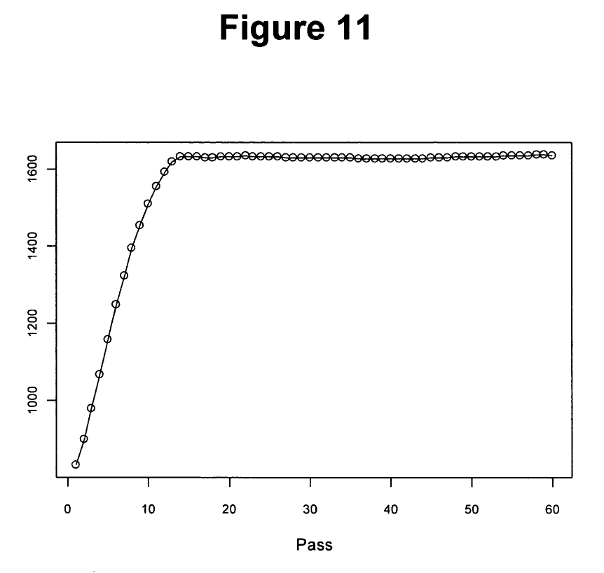

The process then continues to Step 1450 during which the median difference value of the difference values dr₁ through dr₅₉ is determined. Then, in Step 1455, the smoothed normalized values occurring after the step are decreased by the difference average 'dr calculated for the smoothed normalized value at which the step occurred, and then increased by the median difference value calculated in Step 1450. For example, the smoothed normalized values z₅₁ through z₆₀ are each decreased by the magnitude of difference dr₅₀ (the step occurred after the 50^{th} reading) and then the smoothed normalized values z₅₁ through Z₆₀ are each increased by the median difference value calculated in Step 1450. As shown in FIG. 11, this process has the affect of shifting the entire portion of the curve representing the RFU values of z₅₁ through z₆₀ downward, thus eliminating the step.

The processing then proceeds to Step 1460 where it is determined whether the entire process has been repeated two times. If the value of count does not equal two, the value of count is increased by one in Step in 1435, and the processing returns to Step 1410 and repeats as discussed above. However, if the value of count is equal to two, the processing proceeds to the periodic noise filter Step 1500 in the flowchart shown in FIG. 6.

Periodic Noise Filtering Operation

The periodic noise filtering operation 1500 is performed to further filter out erroneous values that may exist in the graph shown in FIG. 11 in which the step has been repaired. Specifically, a five-point moving median is applied to the read values z₁ through Z₆₀ represented in the graph of FIG. 11 to provide filtered values f₁ through f₆₀.

Well Present Operation

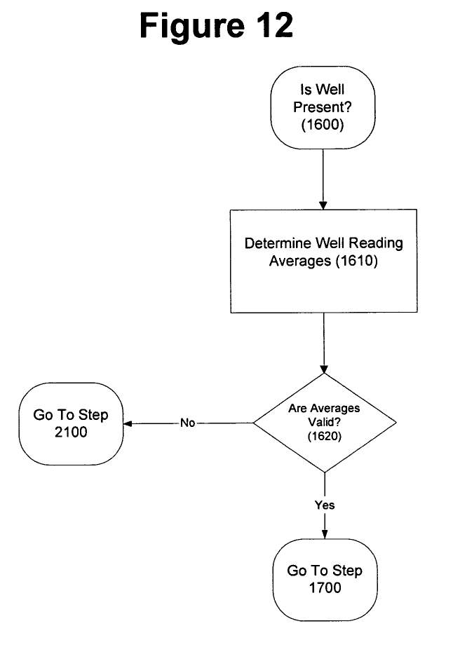

When the data values for each set of values have been first corrected, the controller may perform a well present operation to determine whether a well was present or if the data obtained is entirely erroneous. The processing continues to Step 1600 shown in FIG. 6, in which the processing determines whether the filtered values f₁ through f₆₀, which were derived from the above-described steps from the well readings r₁ through r₆₀, respectively, were actually taken of a well, or, in other words, whether a well was actually present at that location in the microwell array 116 of the sample tray assembly 112. Details of the well present determination processing are shown in the flowchart of FIG. 12.

Specifically, in Step 1610, a well reading average wp_{avg} is determined by adding the filter values f₁₀, f₂₀, f₃₀, f₄₀ and f₅₀, and dividing those values by 5. This well present average wp_{avg} is compared to a well threshold value WP_THRES, which in this example is set to 125.0. If, in Step 1620, the processing determines that the well present average wp_{avg} is greater than zero and less than the threshold value WP_THRES for both targeted sequences, then the processing determines that no well is present and that the data obtained is entirely erroneous. The processing then proceeds to Step 2100 in the flowchart shown in FIG. 6 where processing for that well is concluded and the controller may provide an indication that the well was not present. However, if the processing determines in Step 1620 that either targeted sequence has a well present average wp_{avg} that is greater than the threshold value WP_THRES, then the process determines that a well is present and the processing continues to Step 1700 in the flowchart shown in FIG. 6.

Background Correction Operation

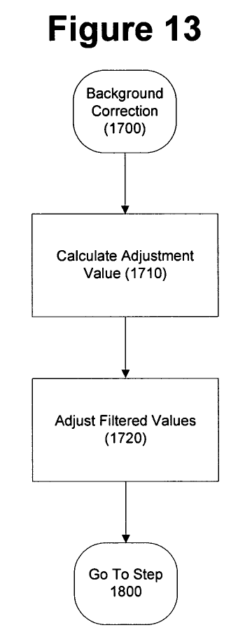

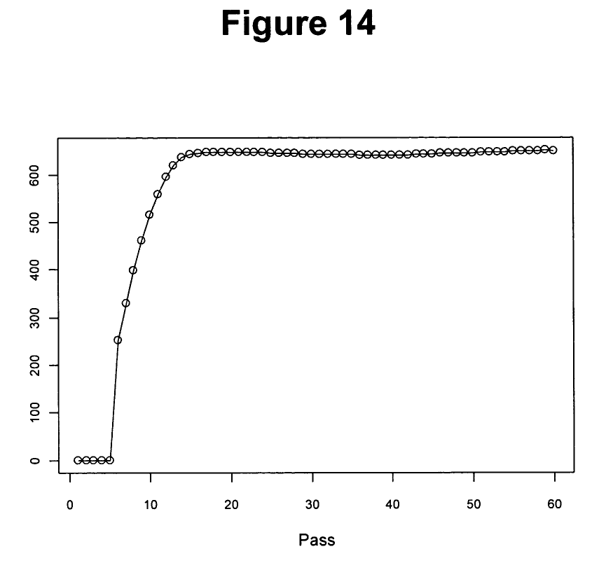

If the well present operation determines that indeed a well was present the controller may proceed to further correct, or adjust, the plurality of data values. In Step 1700, the processing establishes a base line background correction. In Step 1710, a median of filtered value based on, for example, the first five background values f₁ through f₅, is calculated. Other ranges of filtered values, such as f₁₀ through f₁₅, may be used, depending on the assay. This median filtered value is then subtracted from each of the filtered values f₁ through f₆₀. Additionally, the filtered values used to calculate the median filtered value can each be set to zero after being used to calculate the median value, although this is not required. Further details of this background correction operation are shown in the flowchart of FIG. 13. The procedure is done independently for both of the targeted sequences. As shown in the graph of FIG. 14, this processing shifts the portion of the graph between filtered values f, and f₆₀ down toward the horizontal axis.

Reducing Data Values

Signal Ratio Operation

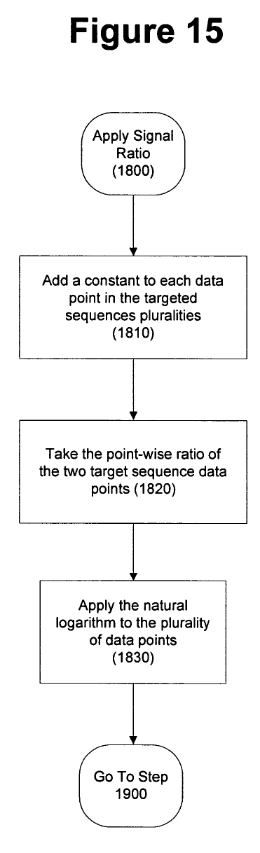

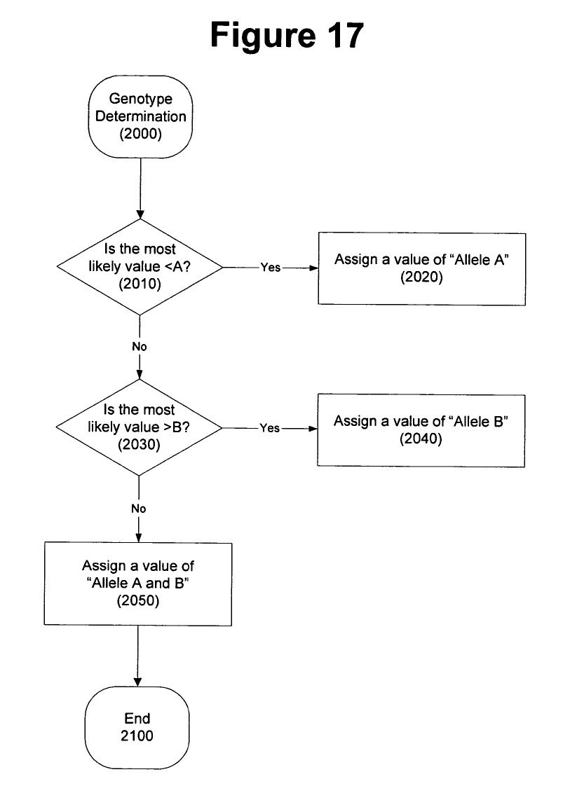

Once the process defined by Steps 1000 through Steps 1720 has been applied independently to two pluralities of values corresponding to separate amplification sequences, the two pluralities are combined into a single plurality of data that measure the relative different between the two pluralities as shown in FIG. 17. An example of a method to relate the curves defined by Step 1720 in FIG. 13 is to take the ratio in step 1800 of the values provided by Step 1720 at each time point after the background slice defined in Step 1700. To improve numerical stability, Step 1810 adds a small, known tolerance value (ε) to each data point prior to the division to avoid division by zero. For example, one set of values (a₆ though a₆₀) are divided by the other set of values (b₆ through b₆₀) to produce a third set of values equal to the ratios c₆=a₆/b₆₀ through c₆₀=a₆₀/b₆₀. This division is defined in Step 1820 in FIG. 15. The method in this embodiment would then proceed to Step 1830 in FIG. 15 where logarithm of these ratios is calculated to produce d₆=log(a₆/b₆). Without loss of generality, the natural logarithm is used in all relevant calculations.

Data Reduction Operation

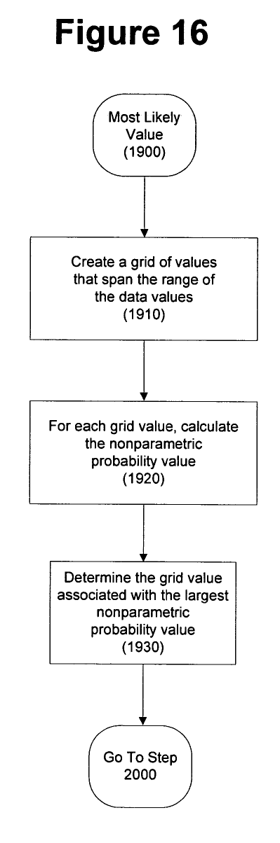

Once the data values for the two pluralities of values have been combined into a single plurality of data values, the plurality of data values is reduced to a single value representative of the plurality of values. For each sample, the plurality of values can be summarized into a single metric in Step 1900 that captures the distribution of the plurality, specifically the magnitude of the values. This procedure is summarized in a flowchart in FIG. 16. There are many different calculations to accomplish this (e.g., mean, median, etc.). In one embodiment, the method is to determine the most likely number that represents the plurality. To accomplish this, a non-parametric probability density (Silverman, 1986) is calculated for a range of possible values (FIG. 16), and the summary metric of the plurality is then the value that corresponds to the value associated with the largest probability density value.

Step 1910 in FIG. 16 creates a grid of equally spaced values that span the range of log-ratio data points determined in Step 1830. Step 1920 calculates the nonparametric density estimate for each of the grid values and Step 1930 determines the grid value associated with the largest probability density value.

Genotype Determination

Once the most likely number is determined, it is compared to two known reference values to determine how the sample is categorized. This process is depicted in FIG. 17. The most likely number is translated to a distinct genotype (e.g., allele A, allele B, heterozygous etc.). In other words, it has been determined from past data readings taken to detect the presence of the targeted sequences that the most likely values from Step 1930 for one genetic variation (e.g., allele A) will exceed a particular reference value and will be below a second reference value if another genetic variation is present (e.g., allele B). If the most likely value is less than the lower reference value (labeled as A in Step 2010 in FIG. 17), the sample is judged to have allele A (Step 2020). In Step 2030, the most likely value is greater than the upper reference value (labeled as B in Step 2030 in FIG. 17), the sample is judged to have allele B (Step 2040). If an allele has not been assigned in Steps 2020 or 2040, Step 2050 judges the sample to have allele A and B. Accordingly, the reference values are chosen to be values that will provide the most accurate indication as to the genotype of the sample. This can be accomplished by choosing reference values that simultaneously maximize sensitivity and specificity for each particular genetic variant at that locus.

The processing then proceeds to Step 2100, where the controller controls the well reading apparatus 100 to report the reported value and provide an indication that the sample in the corresponding well has the determined genotype. This indication can be in the form of a display on the display screen 108, in the form data stored to a disk in the disk drive 106, and/or in the form of a print-out by a printer resident in or attached to the well reading apparatus 100.

As discussed above, the manner in which the samples from patient number one collected in the other sample microwells are read and analyzed is essentially identical to that described above for the sample in the first sample microwell. Specifically, the 60 readings taken of the sample in each of the respective sample microwells are processed according to Steps 1000 through 2100 in FIG. 6 as described above.

The above processing can then be performed for all of the patient samples (or wells) in essentially the same manner. As discussed above, if each patient sample is being tested for multiple genotypes, the microwell array 116 can accommodate samples from (96−4χ)χ) patients where χ is the number of genotypes under investigation. Thus, for analysis of three different genetic mutations from each sample, up to (96−(4×3))/3)=28 patients can be screened at one time. It may be possible to increase the number of patients whose samples can be analyzed at one time by permitting a single negative control without target DNA to act as a control for several different genetic tests.

It is also noted that before any results are reported to patients, the values obtained from reading the allele A, allele B, heterozygous and negative control samples are processed in the manner described above with regard to Steps 1000 through 2100, and the resulting values are analyzed to assure that the control samples have indeed been read correctly. If the readings of any of these control samples are incorrect (e.g., an allele A control has been identified as allele B or vice-versa), all of the sample readings corresponding to the particular genetic test for that locus are called into question for the entire run. All of the sample data for that test must be discarded, and new samples must be gathered in a new microwell array, and then read and evaluated in the manner described above.

### EXAMPLE

Sequence variations within the human β2AR gene and its upstream 5′ untranslated region were used as targets for the development of six different adapter-mediated SNP detection systems according to the method of the invention. SDA systems comprising two bumper primers, two amplification primers and two allele-specific signal primers were designed for each of six SNP sites (−654, −367, −47, +46, +491 and +523). The results listed in this example pertain only to the SNP+46. The two signal primers comprised identical sequences except for the diagnostic nucleotide that was positioned one base upstream from the -3′ terminus (N−1). The same pair of adapter sequences was appended to the 5′ ends of the signal primers to permit detection using a common pair of universal reporter probes. The variant position of the signal oligonucleotide contained adenosine (A), cytosine (C), guanine (G) or thymine (T). For the purposes of this study, “wild-type” allele (or allele A) refers to the sequence illustrated in GeneBank (Accession # M15169), while “mutant” (or allele B) represents the alternative nucleotide (SNP). β2AR target sequences containing allele A and/or allele B were cloned in to pUC19 from pooled human genomic DNA.

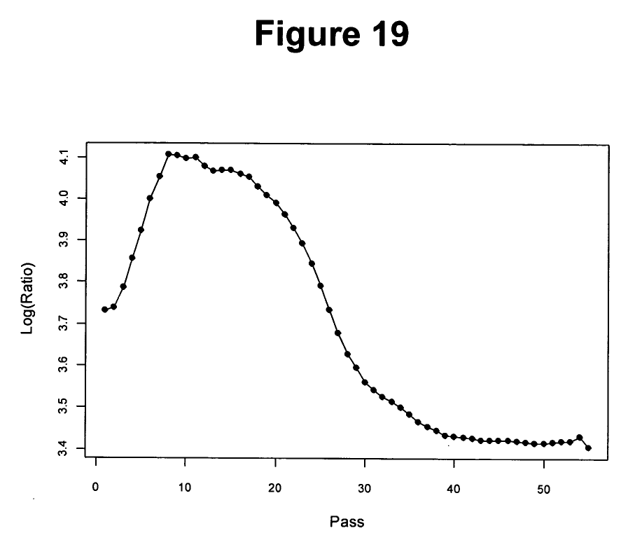

Specific amplification products were detected by monitoring the change in fluorescence intensity associated with the hybridization of a reporter probe to the complement of the appropriate signal primer, the subsequent extension of the signal primer complement and cleavage of the resultant double stranded product. For each well, one fluorescein (FAM) (mutant signal) and one rhodamine (ROX) (wild-type signal) reading were made every minute during the course of the reaction. The FAM and ROX fluorescence readings for each sample were plotted over 60 minutes for one well in FIG. 19. The values on the y-axis are the values obtained in Step 1720. There was a significant increase in ROX fluorescence, over time, compared to a minor increase FAM.

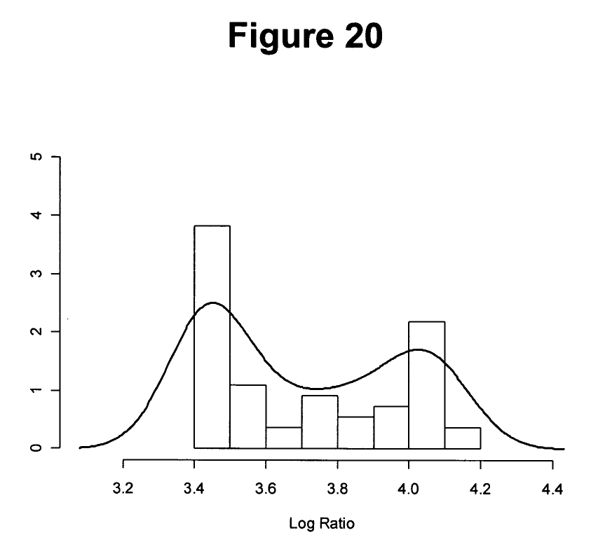

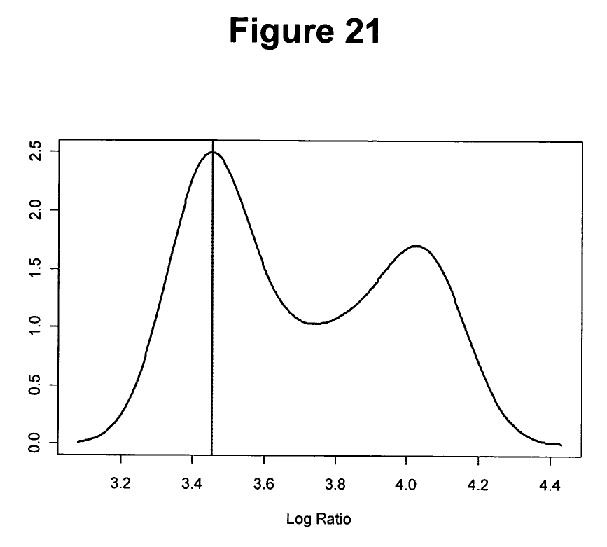

FIG. 19 shows a graph of the log ratio values plotted over time for each data point that occurred after the data that define the background correction. A histogram of these values is provided in FIG. 20, along with the probability density estimate for these data. FIG. 21 demonstrates the steps that define the most likely value for these data (3.45). For this system, values that are between ±1 indicate a heterozygous genotype, whereas values below −1 indicate a mutant genotype and values above +1 indicate a wild-type genotype. This particular sample came from a wild-type.

Although only a few exemplary embodiments of this invention have been described in detail above, those skilled in the art will readily appreciate that many modifications are possible in the exemplary embodiments without materially departing from the novel teachings and advantages of this invention. Similarly, this invention is intended to be broad in scope and to the extent any limitation may appear to be drafted in means-plus-function format, it is intended to broadly cover any structure for achieving the described claim. Accordingly, all such modifications are intended to be included within the scope of this invention as defined in the claims that follow.

What is claimed is:

1. A computerized method for a system to interpret a numerical data pertaining to a sample assay comprising at least one biological or chemical sample, said numerical data including a set of data pertaining to each respective sample, each of said set of data including a plurality of data values, each representing a condition of said respective sample at a point in time, said method comprising the steps of:
for each set of data, performing the steps of:
representing each of said plurality of data values as points on a graph having a vertical axis representing a magnitude of said plurality of data values and a horizontal axis representing a period of time during which readings of said sample were taken to obtain the plurality of data values;
correcting said plurality of data values based on said magnitude of at least one of said plurality of data values;
reducing said plurality of corrected data values for each set of data values;
determining whether said reduced plurality of data values corresponds to a predetermined reference value; and
controlling said system to indicate whether said sample has a predetermined characteristic based on a result of said determining step.

2. The method as claimed in claim 1, wherein said correcting step includes adjusting said magnitude of at least one of said plurality of data values in relation to said magnitude of adjacent ones of said plurality of data values on said graph.

3. The method as claimed in claim 1, further comprising the steps of:
comparing said plurality of corrected data values to a predetermined threshold value; and
further correcting said plurality of corrected data values based on whether said plurality of data values exceeds said predetermined threshold value.

4. The method as claimed in claim 3, wherein when said comparing step determines that said plurality of corrected data values exceeds said predetermined threshold value, said controlling step controls said system to indicate that said sample was not present.

5. The method as claimed in claim 1, wherein said reducing step includes combining each of said plurality of corrected data values for each set of data at respective points in time on said graph and calculating a representative value of the plurality of combined corrected data values for use in said determining step.

6. The method as claimed in claim 1, wherein said correcting step includes calculating said correction values based on a plurality of said data values at a beginning of a sequence of said plurality of data values.

7. The method as claimed in claim 1, wherein when said determining step determines that said reduced plurality of data values corresponds to said predetermined characteristic, said controlling step controls said system to indicate that said sample has said predetermined characteristic.

8. The method as claimed in claim 1, wherein when said determining step determines that said reduced plurality of data values does not corresponds to said predetermined characteristic, said controlling step controls said system to indicate that said sample is absent said predetermined characteristic.

9. A computerized method for a system to analyze a numerical data pertaining to a sample assay, comprising at least one biological or chemical sample, said numerical data including a set of data pertaining to each respective sample, each of said set of data including a plurality of data values, each representing a condition of said respective sample at a point in time, said method comprising the steps of:
for each set of data, performing the steps of:
assigning a respective numerical value to each of said plurality of data values;
correcting said plurality of numerical values pertaining to said set of data;
first comparing said corrected plurality of numerical values to a threshold value;
second correcting said plurality of corrected numerical values based on whether said plurality of corrected exceeds said threshold value;
second comparing said plurality of second corrected numerical values to a reference value corresponding to a predetermined assay; and
controlling said system to indicate whether said sample assay has a predetermined characteristic based on the result of said reference value comparison.

10. The method as claimed in claim 9, wherein said assigning step includes the step of arranging said data values in a sequence representative of said respective points in time.

11. The method as claimed in claim 10, wherein said correcting step includes calculating a correction value based on a plurality of said numerical values at a beginning of said sequence.

12. The method as claimed in claim 11, wherein said correcting step further includes adjusting each of the numerical values of the plurality of data values in relation to an adjacent one of said numerical values.

13. The method as claimed in claim 9, wherein said first comparing step includes calculating an average value of said corrected plurality of numerical values and comparing said average corrected numerical value to said threshold value.

14. The method as claimed in claim 9, wherein said second correcting step includes correcting each of said corrected numerical values in relation to an adjacent one of said corrected numerical values.

15. The method as claimed in claim 14, wherein said second correcting step further includes combining respective ones of said plurality of corrected numerical values for each set of data representative of each respective point in time and summarizing said plurality of combined numerical data values to a numerical value representative of said plurality of combined numerical values.

16. The method as claimed in claim 15, wherein said second comparing step includes comparing said numerical value to said reference value.

17. The method as claimed in claim 10, further comprising the step of assigning to each of said data values a respective time value representative of said respective point in time corresponding to said data value.

18. The method as claimed in claim 9, wherein said controlling step controls said system to report whether said corrected plurality of adjusted numerical values exceeds said threshold value.

19. A computer readable medium of instructions for controlling a system to analyze a numerical data pertaining to a sample assay comprising at least one biological or chemical sample, said numerical data including a set of data pertaining to each respective sample, each of said set of data including a plurality of data values, each representing a condition of said respective sample at a point in time, said medium of instructions comprising:
a first set of instructions, adapted to control said system to represent each of said plurality of data values as points on a graph having a vertical axis representing a magnitude of said plurality of data values and a horizontal axis representing a period of time during which readings of said sample were taken to obtain the plurality of data values;
a second set of instructions, adapted to control said system to correct said plurality of data values based on said magnitude of at least one of said plurality of data values;
a third set of instructions, adapted to control said system to reduce said plurality of corrected data values for each set of data values;
a fourth set of instructions, adapted to control said system to determine whether said reduced plurality of data values corresponds to a predetermined reference value; and
a fifth set of instructions, adapted to control said system to controlling said system to indicate whether said sample has a predetermined characteristic based on a result of the determining step.

20. A computer-readable medium as claimed in claim 19, wherein said second set of instructions is further adapted to control said system to adjust a magnitude of at least one of the plurality of data values in relation to a magnitude of adjacent ones of said plurality of data values on said graph.

21. A computer-readable medium as claimed in claim 19, further comprising a sixth set of instructions adapted to control said system to compare said plurality of corrected data values to a predetermined threshold value and to further correct said plurality of corrected data values based on whether said plurality of corrected data values exceeds said threshold value.

22. A computer-readable medium as claimed in claim 21, wherein when said fourth set of instructions determines that said plurality of data values exceeds said predetermined threshold value, said fifth set of instructions controls said system to indicate that said sample was not present.

23. A computer-readable medium as claimed in claim 19, wherein said third set of instructions is further adapted to control said system to combine each of said plurality of corrected data values for each set of data at respective points in time on said graph and to calculate a representative value of the plurality of combined corrected data values for use in said determining step.

24. A computer-readable medium as claimed in claim 19, wherein said fifth set of instructions is further adapted to control said system to report predetermined characteristic based on said determining step.

25. A computer-readable medium as claimed in claim 19, wherein said fifth set of instructions is further adapted to control said system to indicate that said sample has said predetermined characteristic when said determining step determines that said reduced plurality of data corresponds to said predetermined characteristic.

26. A computer-readable medium as claimed in claim 19, wherein said fifth set of instructions is further adapted to control said system to indicate that said sample is absent said predetermined characteristic when said determining step determines that said reduced plurality of data does not corresponds to said predetermined characteristic.

27. A computerized method for a system to interpret a numerical data pertaining to a sample assay comprising at least one biological or chemical sample, said numerical data including a set of data pertaining to each respective sample, each of said set of data including a plurality of data values, each representing a condition of said respective sample at a point in time, said method comprising the steps of:
for each set of data, performing the steps of:
a means for representing each of said plurality of data values as points on a graph having a vertical axis representing the magnitude of said plurality of data values and a horizontal axis representing a period of time during which readings of said sample were taken to obtain the plurality of data values;
a means for correcting said plurality of data values based on said magnitude of at least one of said plurality of data values;
a means for reducing said plurality of corrected data values for each set of data values;
a means for determining whether said reduced plurality of data values corresponds to a predetermined reference value; and
a means for controlling said system to indicate whether said sample has a predetermined characteristic based on a result of the determining step.

28. The method as claimed in claim 27, wherein said correcting means includes a means for adjusting a magnitude of at least one of the plurality of data values in relation to a magnitude of adjacent ones of said plurality of data values on said graph.

29. The method as claimed in claim 27, further comprising the steps of:
a means for comparing said plurality of data values to a predetermined threshold value; and
a means for further correcting said plurality of corrected data values based on whether said plurality of data values exceeds said predetermined threshold value.

30. The method as claimed in claim 27, wherein when said comparing means determines that said plurality of corrected data values exceeds said predetermined threshold value, said controlling means control said system to indicate that a sample was not present.

31. The method as claimed in claim 27, wherein said reducing means includes a means for combining each of said plurality of corrected data values for each set of data at respective points in time on said graph and a means for calculating a representative value of the plurality of combined corrected data values for use by said determining means.

32. The method as claimed in claim 27, wherein said controlling means controls said system to report said predetermined characteristic based on said determining means.

33. The method as claimed in claim 27, wherein when said determining means determines that said reduced plurality of data corresponds to said predetermined characteristic, said controlling means controls said system to indicate that said sample has said predetermined characteristic.

34. The method as claimed in claim 27, wherein when said determining means determines that said reduced plurality of data does not corresponds to said predetermined characteristic, said controlling means controls said system to indicate that said sample is absent said predetermined characteristic.
